(19) United States
(12) Patent Application Publication
(10) Pub. No.: US 2026/0158635 A1
(43) Pub. Date: Jun. 11, 2026

(54) Actuator for Actuating a Switch of a Powered Device that is Magnetically Holdable in a Plurality of Positions

(71) Applicant: Black & Decker, Inc., New Britain, CT (US)

(72) Inventors: Luca BARDARÉ, Marburg (DE); Benjamin SCHMIDT, Mainz (DE); Tobias HEEP, Steinbach (DE); Yasar AKBABA, Neu-Isenburg (DE); Kevin BHIKADIYA, Frankfurt am Main (DE)

(21) Appl. No.: 19/178,402

(22) Filed: Apr. 14, 2025

(30) Foreign Application Priority Data
Apr. 15, 2024 (EP) 24170306

(51) Int. Cl. B25F 5/02; B25D 16/00; H01H 9/20; H01H 19/14

(52) U.S. Cl. CPC B25F 5/02; H01H 9/20; H01H 19/14; B25D 16/006; B25D 2216/0084

(57) ABSTRACT

An actuator for actuating a switch of a powered device having a plurality of positions in which the actuator is magnetically held in position. The actuator includes a first actuator portion including a magnet and a first magnetic element having a first plurality of limbs, whereby magnetic flux of the magnet is directed through the first plurality of limbs; and a second actuator portion including a second magnetic element having a second plurality of limbs for receiving the magnetic flux from the first plurality of limbs. The actuator has a plurality of positions in which limbs of the first plurality of limbs align with limbs of the second plurality of limbs thereby to couple the magnetic flux in a flux loop through two limbs of the first plurality of limbs of the first magnetic element and two limbs of the second plurality of limbs of the second magnetic element.

### CROSS-REFERENCE TO RELATED APPLICATIONS

The present application claims priority to European Patent Application No. EP 24170306.5 filed on Apr. 15, 2024, which is herein incorporated by reference in its entirety.

### BACKGROUND OF THE INVENTION

### Field of the Invention

The present disclosure relates to an actuator for actuating a switch of a powered device, the actuator having a plurality of positions in which the actuator can be magnetically held in position.

### Description of the Related Art

Some powered devices such as power tools have multiple functions or modes of operation. An example of a power tool with multiple modes of operations is a drill having, for example a drill mode, a hammer drill mode and a hammer only mode. Such power tools comprise a user-operable actuator for switching between the different modes. Another example is a drill that has selectable gears for a required speed and/or torque. The actuator is typically a rotatable actuator. The actuator has different positions, each corresponding to one of the different modes of operation. To avoid accidental operation of the actuator, the actuator typically comprises a mechanical locking system. Such mechanical locking systems can comprise a spring-loaded detent which catches in a depression to resist movement of the actuator between its different positions unless a user presses a release button, enabling movement of the actuator between its different positions.

Operating the release button can be cumbersome and awkward when the power tool is being used in a confined environment. Moving the release button and/or the detent, and indeed moving the actuator itself, can cause wear and tear on parts of the actuator mechanism. Over time, this can lead to failure of the actuator.

It is desirable for the actuator to have improved wear resistance and/or to be easier to operate, whilst maintaining a function to prevent accidental operation of the actuator.

### SUMMARY OF THE INVENTION

According to an aspect of the present invention, there is provided an actuator for actuating a switch of a powered device, the actuator having a plurality of positions in which the actuator is magnetically held in position, the actuator comprising: a first actuator portion comprising a magnet and a first magnetic element having a first plurality of limbs, whereby magnetic flux of the magnet is directed through the first plurality of limbs; and a second actuator portion comprising a second magnetic element having a second plurality of limbs for receiving the magnetic flux from the first plurality of limbs, wherein the second actuator portion is movable relative to the first actuator portion; the actuator having a plurality of positions in which limbs of the first plurality of limbs align with limbs of the second plurality of limbs thereby to couple the magnetic flux through the first magnetic element and the second magnetic element, the coupled magnetic flux resisting relative movement between the first actuator portion and the second actuator portion.

According to another aspect of the present invention, there is provided an actuator for actuating a switch of a powered device, the actuator having a plurality of positions in which the actuator is magnetically held in position, the actuator comprising: a first actuator portion comprising a magnet and a first magnetic element having a first plurality of limbs, whereby magnetic flux of the magnet is directed through the first plurality of limbs; and a second actuator portion comprising a second magnetic element having a second plurality of limbs for receiving the magnetic flux from the first plurality of limbs, wherein the second actuator portion is movable relative to the first actuator portion; the actuator having a plurality of positions in which limbs of the first plurality of limbs align with limbs of the second plurality of limbs thereby to couple the magnetic flux in a flux loop through two limbs of the first plurality of limbs of the first magnetic element and two limbs of the second plurality of limbs of the second magnetic element, the coupled magnetic flux resisting relative movement between the first actuator portion and the second actuator portion.

The actuator thus has a resistance to movement away from a position of the actuator in which it is magnetically held in position. The actuator is held in place by the magnetic flux flowing through the first magnetic element and the second magnetic element.

Suitably one or more of a strength and/or a size of the magnet, a material of the first magnetic element and/or a material of the second magnetic element, are selected in dependence on a desired force with which the actuator is magnetically held in position. The force with which the actuator is held in position, can therefore be selected as desired for a given application or use of the actuator.

Suitably one or more of a size and/or shape of the first magnetic element, a size and/or shape of the second magnetic element, a spacing between the first magnetic element and the second magnetic element, a direction of relative movement between the first magnetic element and the second magnetic element, are selected in dependence on a desired force with which the actuator is magnetically held in position. The force with which the actuator is held in position, can therefore be selected as desired for a given application or use of the actuator.

The magnet may comprise a permanent magnet and/or an electromagnet. This arrangement permits a compact actuator to be provided, whilst enabling a variable magnetic strength when desired. The strength of the electromagnet may be controllable in dependence on an expected vibration and/or a measured vibration. This arrangement permits the retention of the actuator in the desired position in a variety of use cases.

The actuator may have a first position in which a first set of limbs comprising two or more limbs of the first plurality of limbs aligns with a second set of limbs comprising two or more limbs of the second plurality of limbs. Thus, the magnetic flux from the magnet that is coupled into the first magnetic element and into the second magnetic element resists movement of the actuator away from the first position. The actuator is thereby magnetically held in the first position.

The actuator may have a second position in which a third set of limbs comprising two or more limbs of the first plurality of limbs aligns with a fourth set of limbs comprising two or more limbs of the second plurality of limbs, where the first set of limbs differs from the third set of limbs; and/or the second set of limbs differs from the fourth set of limbs. The coupled magnetic flux resists movement of the second actuator portion relative to the first actuator portion.

The first plurality of limbs may be unitarily formed. The first plurality of limbs may be unitarily formed with the remainder of the first magnetic element. That is, the first magnetic element, including the first plurality of limbs, may be unitarily formed. The second plurality of limbs may be unitarily formed. The second plurality of limbs may be unitarily formed with the remainder of the second magnetic element. That is, the second magnetic element, including the second plurality of limbs, may be unitarily formed. The manufacturing and/or assembly process can thereby be simplified and/or costs reduced.

A number of limbs of the first magnetic element may equal a number of limbs of the second magnetic element. Providing the first magnetic element and the second magnetic element with the same number of limbs helps to ensure alignment between limbs of each element as the first and second magnetic elements move past one another. This arrangement helps ensure that the actuator can be magnetically secured in a plurality of positions.

A number of limbs of the first magnetic element may be greater than a number of limbs of the second magnetic element. Where the number of limbs of the first magnetic element and the second magnetic element differ, it can be advantageous to provide the greater number of limbs on the magnetic element that moves less relative to a body of a powered device in which the actuator is used, or which does not move relative to the body of the powered device in which the actuator is used. Where the second magnetic element moves past the first magnetic element (which suitably does not move as much, if at all), and the second magnetic element has relatively fewer limbs, the extent of travel of the second magnetic element can be shorter than when the second magnetic element has relatively more limbs. Thus, arrangements in which the second magnetic element has fewer limbs than the first magnetic element (e.g. where the second magnetic element has two limbs and the first magnetic element has three limbs) can result in more compact arrangements than might otherwise arise where the second magnetic element has more limbs than the first magnetic element (e.g. where the second magnetic element has three limbs and the first magnetic element has two limbs).

Suitably, one or both of the first magnetic element and the second magnetic element comprises at least three limbs. Providing one or both of the first magnetic element and the second magnetic element with three limbs gives additional configurations in which limbs of each element can align with limbs of the other element. This results in additional positions in which the actuator can be magnetically held in place. Further, where three limbs of the first magnetic element align with three limbs of the second magnetic element, magnetic flux can flow in two loops. This strengthens the force with which the actuator is magnetically held in position.

Limbs of the first plurality of limbs of the first magnetic element may be spaced from each other by a separation distance, and limbs of the second plurality of limbs of the second magnetic element may be spaced from each other by the same separation distance. Providing the same spacing between two limbs of the first magnetic element as between two limbs of the second magnetic element helps with the alignment of limbs between the first magnetic element and the second magnetic element. In turn, the improved alignment helps couple magnetic flux more efficiently from the first magnetic element into the second magnetic element. This can improve the force with which the actuator is held in position. The spacing may be a linear spacing or an angular spacing.

Limbs of the first plurality of limbs of the first magnetic element may be equally spaced from adjacent limbs. Providing equally-spaced limbs on the first magnetic element can help improve alignment of multiple pairs of limbs of the first magnetic element with two limbs of the second magnetic element. This arrangement can thereby improve the force with which the actuator is magnetically held in position. The spacing may be a linear spacing or an angular spacing.

Limbs of the second plurality of limbs of the second magnetic element may be equally spaced from adjacent limbs. Providing equally-spaced limbs on the second magnetic element can help improve alignment of multiple pairs of limbs of the second magnetic element with two limbs of the first magnetic element. This arrangement can thereby improve the force with which the actuator is magnetically held in position. The spacing may be a linear spacing or an angular spacing.

One more limbs of the first magnetic element may have at least one of: a different circumferential width, a different axial width, and a different length, compared to one or more limbs of the second magnetic element. Varying one or more of the circumferential width, axial width and length of the limbs can vary the force with which the actuator is held in position.

The actuator may comprise biasing means. The biasing means may be configured to bias the actuator towards an actuator position. The actuator may comprise a resilient element. The resilient element may be configured to bias the actuator towards an actuator position.

The second actuator portion may be rotatably movable relative to the first actuator portion. Rotational movement between the second actuator portion and the first actuator portion can lead to a more compact actuator configuration.

The first plurality of limbs of the first magnetic element may be radially exterior to the second plurality of limbs of the second magnetic element. This arrangement can provide for a more compact movable portion of the actuator.

The magnet may be radially between the first magnetic element and the second magnetic element. This arrangement can provide a compact actuator.

At least a portion of the actuator may be formed by additive manufacturing. Forming one or more portions or components of the actuator by additive manufacturing can mean that that portion or component can be manufactured more quickly/cheaply/to be lighter than using other manufacturing methods.

One or both of the first magnetic element and the second magnetic element may be at least partially ferromagnetic. Forming the first magnetic element and/or the second magnetic element partially or wholly from a ferromagnetic material can help couple the magnetic flux from the magnet into these elements.

One or both of the first magnetic element and the second magnetic element may be at least partially made from metal. One or both of the first magnetic element and the second magnetic element may be formed by a milling process. Forming the one or both of the first magnetic element and the second magnetic element by milling can mean that one or both of these elements can be formed so as to reduce the volume of material needed for a given structural strength.

According to another aspect of the present invention, there is provided a powered device comprising an actuator as described herein. One of the first actuator portion and the second actuator portion may be movable relative to a device body of the powered device. The other of the first actuator portion and the second actuator portion is suitably fixed or non-movable relative to the device body. It may be sufficient if the other of the first actuator portion and the second actuator portion moves relative to the device body to a lesser extent than the one of the first actuator portion and the second actuator portion. This arrangement permits a user to manipulate the one of the first actuator portion and the second actuator portion so as to change the configuration of the actuator. The powered device may be a powered hand tool. The powered device may be powered by a battery.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1 shows an example of a power tool comprising an actuator;

FIG. 2 shows an example of an actuator having a plurality of positions in which the actuator can be magnetically held in position;

FIG. 3 shows an exploded view of the actuator shown in FIG. 2;

FIG. 4 shows operation of the actuator of FIG. 2;

FIGS. 5A and 5B show a locking principle of the actuator of FIG. 2;

FIGS. 6A, 6B and 6C show different positions of the actuator of FIG. 2;

FIGS. 7A and 7B show operation of an alternative actuator configuration;

FIGS. 8A and 8B show operation of another alternative actuator configuration;

FIGS. 9A and 9B show operation of another alternative actuator configuration;

FIGS. 10A, 10B and 10C show operation of another alternative actuator configuration;

FIGS. 11A and 11B show another alternative actuator configuration; and

FIGS. 12A and 12B show another alternative actuator configuration.

The accompanying drawings illustrate various examples. Common reference numerals are used throughout the figures, where appropriate, to indicate similar features.

### DESCRIPTION OF THE INVENTION

The following description is presented by way of example to enable a person skilled in the art to make and use the invention. The present invention is not limited to the embodiments described herein and various modifications to the disclosed embodiments will be apparent to those skilled in the art.

The present disclosure describes an actuator for a powered device, such as a power tool. The actuator has a plurality of positions in which the actuator is magnetically held in position.

By way of example, the actuator may be a mode control actuator for a powered drill. More generally the power tool may be any kind of power tool. For example, the power tool can be a power tool that has multiple modes of operation. Where the power tool is a drill, the drill can have different drill modes such as a standard drill mode, a hammer drill mode and a hammer-only mode. A power tool having driven rotary motion, such as a drill, may be operable to drive the rotary motion in a clockwise direction in one mode of operation and an anti-clockwise (counter-clockwise) direction in another mode of operation. The actuator may be an actuator for an electronic or mechanical switch. For example, the power tool may be a saw with different saw operating modes such as speeds of a rotary or reciprocating saw blade, wherein the speeds are controlled by an electronic switch which is actuated by the actuator. The power tool may be a pump with different pump speeds in different modes of operation, or suck and blow functions in different modes of operation such as leaf vacuums or leaf blowers. The actuator can be an operation control actuator as well as or instead of a mode control actuator. The actuator can be an actuator for a mechanical switch such as a gear switch for a drill. Suitably, such a gear switch is configured to change a gear of the power tool, for example for driving the power tool at a different speed or with a different torque.

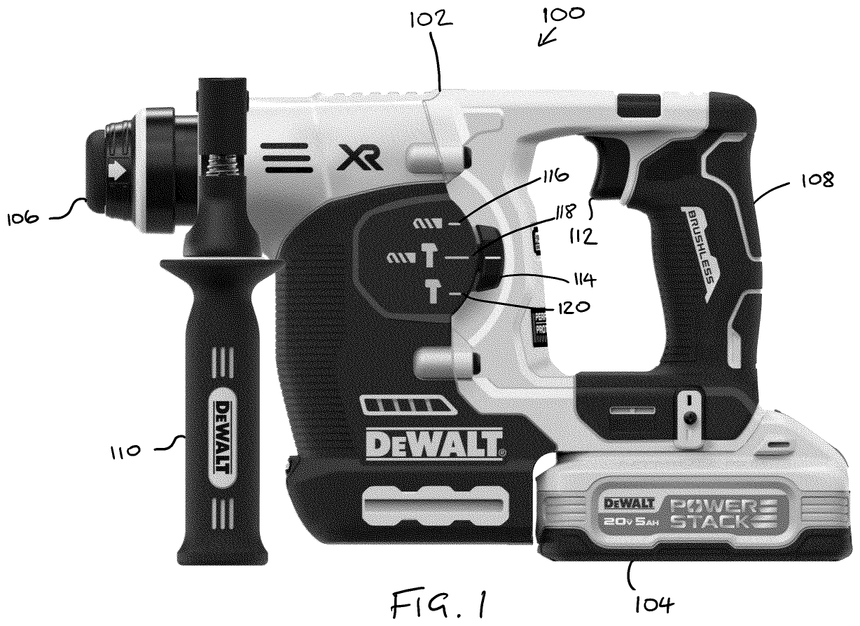

An example of a power tool having a mode control actuator is illustrated in FIG. 1. FIG. 1 shows a drill 100. The drill 100 is an example of a hand tool. In the illustrated example, the drill 100 is a battery-powered hand tool. The drill 100 comprises a body 102, a battery pack 104 coupled to the body 102 and a rotary drive shaft 106 partially extending from the body 102. Handles 108, 110 are formed as part of or coupled to the body 102 and enable a user to comfortably hold the drill 100 in use. A trigger switch 112 is provided for controlling operation of the drill.

The drill further has a mode control actuator 114 for controllably switching between different modes of operation of the drill. In the illustrated example, the drill 100 has a drill mode, a hammer drill mode and a hammer-only mode. The actuator is locatable at a number of positions corresponding to the number of modes. In this example, the actuator is locatable in a drill position 116 (corresponding to the drill mode), a hammer drill position 118 (corresponding to the hammer drill mode) and a hammer-only position 120 (corresponding to the hammer-only mode). In other examples, there may be only two modes, or two positions of this actuator 114. In yet other examples, there may be four or more modes, or four or more positions of this actuator 114. Thus, whilst the actuator 114 will be described herein with reference to an implementation having three positions, it should be appreciated that this is not limiting on the present techniques.

The actuator is accessible and controllable from the rear of the drill 100 (taking a drilling direction as a forwards direction, i.e. ‘front’ is to the left in FIG. 1, and ‘rear’ is to the right). This contrasts with other types of actuator which are accessed and controlled ‘face on’, typically by grasping a protrusion and rotating that protrusion about a centre of that protrusion. As will become apparent from the description herein, the present arrangement of the actuator permits operation of the actuator from a more oblique angle (i.e. off-normal) than conventional rotatable actuators, meaning that the present actuator can be operated more conveniently, even in constrained areas.

The present inventors have identified that an issue with existing mechanical shifting systems or mechanical actuators is the abrasion between component parts of the mechanical actuator when the mechanical actuator is operated. This abrasion occurs when parts touch one another as they move past one another. Over time, this abrasion leads to wear and tear on the components of the mechanical actuator. Such wear and tear can lead to failure of the mechanical actuator, often within an expected lifetime of the power tool itself. This is undesirable.

Further, the contact between different components of such mechanical actuators can cause unwanted noise. The issue of unwanted noise may increase as wear and tear on the component parts of the mechanical actuator increases.

Another issue with mechanical actuators is haptic friction. Such friction can be caused by the abrasion between component parts of the mechanical actuator. The haptic friction can be undesirable as it may lead to an additional force to overcome when operating the actuator. Such an additional force can cause the operation of the actuator to become more difficult, or less comfortable to a user. Such haptic friction can also cause unwanted vibrations in actuator components when operating the mechanical actuator. Such unwanted vibrations may lead the user to think that the mechanical actuator is in a different actuator position to an intended actuator position, potentially causing errors in the operation of the device comprising the mechanical actuator. Haptic friction when operating the mechanical actuator can add to user fatigue, especially where the actuator is operated frequently in a short time period.

Whilst component part wear and tear can be ameliorated by the use of harder materials, this can come at a cost of increased weight of the mechanical actuator, and/or an increased financial cost of using harder materials. There may also be a manufacturing cost, since harder materials are more likely to be more difficult and/or more expensive to manufacture.

The techniques discussed herein attempt to address at least some of the identified issues.

The present techniques relate to an actuator with a plurality of positions in which the actuator is magnetically, rather than just mechanically, held in position. Holding an actuator in position magnetically has the advantage that there can be a reduction in friction when operating the actuator. This is because component parts of the actuator do not need to contact each other to hold the actuator in a given position. Rather, the actuator is held in the given position under magnetic force.

Where friction between component parts that cause the actuator to be held in a given position is reduced, or completely avoided, the abrasion between component parts, and hence wear and tear on those component parts, is also reduced or avoided. Reducing or avoiding such friction between component parts also enables better haptic to be felt by a user.

Thus, such an actuator can have magnetic engagement in different positions of the actuator. Such an actuator can be more comfortable to operate. Such an actuator can be more durable and long lasting.

An actuator that is magnetically holdable in different positions can be considered to be a type of floating magnetic locking system.

An example of an actuator that can be magnetically held in different positions is illustrated in FIG. 2. The actuator 200 comprises a first actuator portion 210 and a second actuator portion 220. The first actuator portion 210 comprises one or more recesses for housing parts of the first actuator portion. The first actuator portion comprises a magnet recess 230 for housing a magnet. The first actuator portion comprise multiple magnetic element recesses 240, 242, 244 for housing limbs 250, 252, 254 of a first magnetic element 260.

The second actuator portion 220 comprises an arm 270 extending from a central portion of the second actuator portion 220. A knob or handle 280 for operation by a user is provided at the end of the arm 270.

In the example illustrated in FIG. 2, the second actuator portion 220 is rotationally mounted to the first actuator portion 210, and is configured to rotate about a rotational axis 290. A user can move the knob 280 up or down (along its arc of movement) to effect a change in the actuator position.

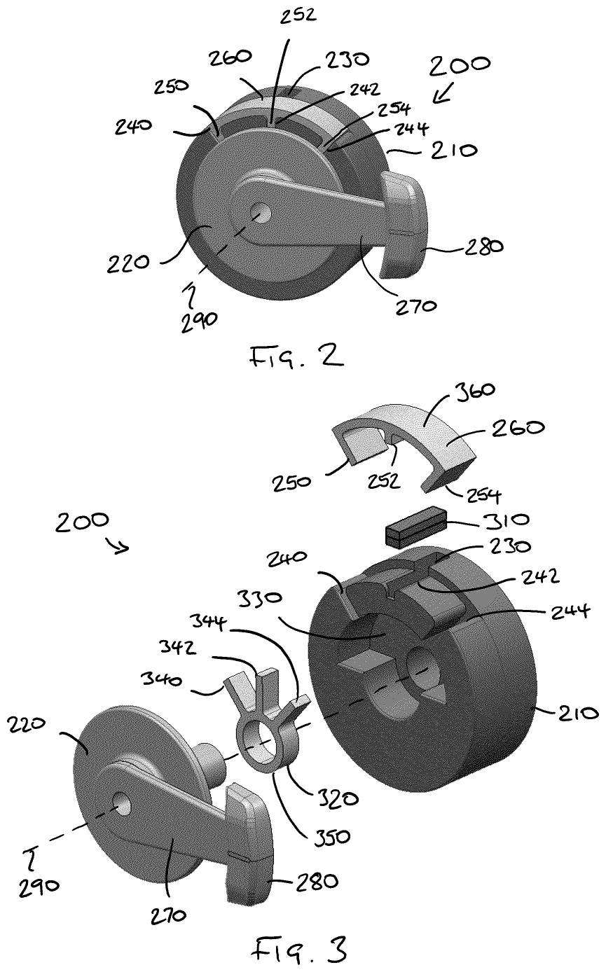

The example actuator of FIG. 2 is shown in exploded view in FIG. 3. FIG. 3 illustrates the magnet 310 that can be housed in the magnet recess 230. The second actuator portion 220 comprises a second magnetic element 320. The second magnetic element 320 is mountable to the second actuator portion 220 so as to move together with the second actuator portion. That is, the second magnetic element 320 and the second actuator portion 220 move in registration with each other. The second actuator portion 220, and hence the second magnetic element 320, is movable relative to the first actuator portion 210.

The first actuator portion 210 comprises a central recess 330 for receiving the second magnetic element 320 when the actuator is assembled. The central recess 330 is sufficiently large to house the second magnetic element and to permit movement of the second magnetic element, in this example rotationally, as will be explained further elsewhere.

The second actuator portion 220, including the second magnetic element 320, and the first actuator portion 210 are located on the axis of rotation 290. When in an assembled state, the second magnetic element 320 is axially aligned with the first magnetic element 260. The second magnetic element 320 is located radially inside the first magnetic element 260. As the second magnetic element moves, it need not remain within the circumferential extent of the first magnetic element. The radially outermost portion of the second magnetic element is, however, within the radially innermost portion of the first magnetic element.

The second magnetic element 320 comprises limbs 340, 342, 344. The limbs of the second magnetic element extend radially outwardly from a body 350 of the second magnetic element. The body of the second magnetic element is in the form of an inner ring 350 of the second magnetic element 320. In the illustrated example, the inner ring 350 is a complete ring, with a circumferential extent that surrounds the axis of rotation 290. This is not necessary in all examples. It may be sufficient that the body (inner ring) 350 of the second magnetic element joins each of the limbs 340, 342, 344 of the second magnetic element. That is, the body (inner ring) 350 of the second magnetic element need not extend past either end of the row of limbs 340, 342, 344. Providing the inner ring 350 as a complete ring can aid in structural stability of the second magnetic element 320. Providing the inner ring 350 as a partial ring can aid in reducing the weight of the second magnetic element.

The first magnetic element 260 comprises limbs 250, 252, 254. The limbs of the first magnetic element extend radially inwardly from a body 360 of the first magnetic element. The body of the first magnetic element is in the form of a circumferential portion 360 of the first magnetic element 260. In the illustrated example, the circumferential portion 360 extends around only a portion of the circumference of the first actuator portion 210. In other examples, the body (circumferential portion) 360 of the first magnetic element can extend around a greater amount of the circumference, and even the whole circumference, of the first actuator portion 210. It is sufficient, however, that the body (circumferential portion) 360 of the first magnetic element joins each of the limbs 250, 252, 254 of the first magnetic element 260. That is, the body (circumferential portion) 360 of the first magnetic element 260 need not extend past either end of the row of limbs 250, 252, 254.

FIG. 4 illustrates, via arrows 410, 420, relative rotational movement between the second actuator portion 220 and the first actuator portion 210.

Suitably, the first actuator portion 210 is in fixed relative position with respect to a device on which the actuator 200 is mounted. That is, the first actuator portion is not movable relative to the device. The second actuator portion 220 is movable relative to the device, and hence also relative to the first actuator portion 210.

In the actuator illustrated in FIGS. 2, 3 and 4, there are three limbs on the first magnetic element and three limbs on the second magnetic element. As will be described later, it is not necessary for there to be the same number of limbs on each of the first magnetic element and the second magnetic element. The limbs on the first magnetic element extend from the body of the first magnetic element. The limbs on the first magnetic element are separated from one another. In the configuration illustrated in FIG. 4, the limbs are circumferentially separated from one another. As illustrated, the limbs extend radially from the body of the first magnetic element. The limbs on the second magnetic element extend from the body of the second magnetic element. The limbs on the second magnetic element are separated from one another. In the configuration illustrated in FIG. 4, the limbs are circumferentially separated from one another. As illustrated, the limbs extend radially from the body of the second magnetic element.

Suitably, the first magnetic element 260 and the second magnetic element 320 have the same width in an axial direction, i.e. along the axis of rotation 290. Since the first magnetic element and the second magnetic element align with one another along the axial direction, providing both elements 260, 320 with the same axial width means that the elements overlap one another, with no overhang of either element to either side in the axial direction. This arrangement maximises the efficiency of magnetic coupling between the two elements 260, 320.

Suitably, as best illustrated in FIG. 5, the limbs of the first magnetic element 260 and the second magnetic element 320 are of the same thickness in a circumferential direction. This arrangement means that the ends of the limbs, when in alignment, overlap one another, with no overhang to either side in the circumferential direction. This arrangement maximises the efficiency of magnetic coupling between the two elements 260, 320.

As will be understood with reference to FIG. 5A, the magnet 310 is suitably located adjacent a limb of the first magnetic element 260. In the illustrated example, the magnet 310 is located adjacent a central limb 252 of the first magnetic element. That is, the first actuator portion 210 is configured such that the magnet recess 230 is located radially inwardly of the radially innermost extent of a central magnetic element recess 242. Suitably, when the magnet 310 and the first magnetic element 260 are located in their respective recesses, the radially innermost end of the central limb 252 of the first magnetic element 260 will abut, or be very close to, the radially outermost surface of the magnet 310. Suitably, the first actuator portion is configured so that the radially innermost portion of the magnet recess is located at a radial distance that is the same as a radially innermost portion of the magnetic element recesses that are not adjacent the magnet recess. This arrangement means that the radially innermost portion of the magnet will be at the same radial distance as the radially innermost portion of the limbs of the first magnetic element, other than the limb of the first magnetic element that is adjacent the magnet. Hence, as illustrated in FIG. 5A, alignment of the magnet and of the first magnetic element limbs (other than the limb of the first magnetic element that is adjacent the magnet) with the limbs of the second magnetic element means that a small gap is maintained between the respective limbs. Keeping this gap small improves the efficiency with which magnetic flux can be coupled between the first magnetic element and the second magnetic element.

Suitably, distal ends of the limbs of the second magnetic element are located at the same radial distance as each other. That is, the limbs extend to the same distance from the axis of rotation 290. This arrangement means that the limb in a given orientation or position extends by the same amount irrespective of the position of the actuator. This arrangement therefore enables a consistent alignment and relative positioning between limbs of the second magnetic element and the limbs of the first magnetic element.

When the second actuator portion 220 is mounted to the first actuator portion 210, a limb of the second magnetic element is suitably located adjacent the magnet recess 230. Thus, when the magnet 310 is located in the magnet recess 230, a limb of the second magnetic element is suitably located adjacent the magnet 310. That is, the actuator is configured such that the magnet recess 230 is located radially outwardly of the radially outermost extent of a limb of the second magnetic element 320. Suitably, when the magnet 310 is located in the magnet recess 230 and the actuator 200 is assembled so that the second magnetic element 320 is located in the central recess 330 of the first actuator portion 210, the radially outermost end of a limb 340, 342, 344 of the second magnetic element 320 will be close to the radially innermost surface of the magnet 310. Preferably the second magnetic element 320 and the magnet 310 will not abut one another. This is because the limbs of the second magnetic element are movable relative to the magnet as the actuator is operated, and it is desirable that there is no abrasion between the magnet and the second magnetic element.

The principle of operation of the actuator will now be described with reference to FIGS. 5A and 5B. FIG. 5B illustrates a typical bar magnet, and the lines of magnetic flux connecting the north and south poles of the magnet. In FIG. 5B, the magnetic flux lines are shown as would occur in free space.

It is noted that whilst the figures illustrate the magnet as a bar magnet, this is not necessary in all examples. The magnet may comprise a permanent magnet (such as a bar magnet) and/or an electromagnet. Where the magnet comprises a permanent magnet, the arrangement can thereby be compact and lightweight. Where the magnet comprises a permanent magnet, the magnet need not be coupled to an electric power source, which reduces manufacturing complexity. Thus, this arrangement can aid the manufacturing process.

Where the magnet comprises an electromagnet, the strength of the magnet can be controllable. The strength of the magnet can be controllable in dependence on a desired resistance force (to motion between the first actuator portion and the second actuator portion). Where misalignment occurs between limbs of the first magnetic element and limbs of the second magnetic element, increasing the magnetic flux of the magnet can act to accommodate this misalignment. For example, a force resisting movement between the first and second actuator portions can be maintained despite the misalignment. Thus, providing an electromagnet with a controllable magnetic strength can reduce the effects of misalignment. Such misalignment might occur due to wear on the actuator. Thus, providing the electromagnet can improve the useful life of the actuator, and/or reduce the need for repair or realignment of the actuator.

The magnet may comprise a permanent magnet and an electromagnet. This arrangement permits use of the actuator without draining power (where the electromagnet is not needed), but enables a stronger magnet to be provided as desired (by controlling the electromagnet), for example in a given position of the plurality of positions of the actuator, and/or due to misalignment.

It can be useful to provide a stronger and/or a variable strength of magnet to assist in retaining the actuator in a given position where the powered device is likely to experience vibrations. Suitably, the strength of the electromagnet can be controlled in dependence on an expected or measured vibration, for example a frequency of vibration and/or an amplitude of vibration. This allows the strength of the magnet to be set at an optimal level, e.g. sufficiently strong to retain the actuator in the desired position, but without wasting power by providing an electromagnet that is stronger than needed. This can help increase battery life of a powered hand tool.

Preferably, a single magnet (a permanent magnet and/or an electromagnet) is provided. The first and second magnetic elements couple flux of the magnet. Thus, it is sufficient for a single magnet to be provided to enable a flux circuit to be set up that includes a portion of the first magnetic element and a portion of the second magnetic element. Providing a single magnet can assist with reducing cost and/or complexity of manufacture.

In the rotational configurations described herein, the magnet is preferably provided radially between a portion of the first magnetic element and a portion of the second magnetic element. This arrangement can help keep the actuator axially compact. In such arrangements, the magnetic flux loop through two limbs of one magnetic element and two limbs of the other magnetic element suitably occurs generally in a plane perpendicular to the axis of rotation.

The limbs of the first magnetic element can be of the same material as the body of the first magnetic element. Preferably, the limbs of the first magnetic element are unitarily formed with the body of the first magnetic element. This can simplify manufacture of the first magnetic element, and assembly of the actuator. The limbs of the second magnetic element can be of the same material as the body of the second magnetic element. Preferably, the limbs of the second magnetic element are unitarily formed with the body of the second magnetic element. This can simplify manufacture of the second magnetic element, and assembly of the actuator. Preferably, the multiple limbs of the magnetic elements are not themselves magnets, but are of a material for coupling magnetic flux, so as to couple flux from the separate magnet through the magnetic elements.

FIG. 5A shows how the magnetic flux is coupled through the first magnetic element 260 and the second magnetic element 320 in certain positions of the actuator, i.e. in certain relative positions between the second actuator portion 220 and the first actuator portion 210.

FIG. 5A shows the actuator in a configuration in which three limbs 340, 342, 344 of the second magnetic element 320 align with three limbs 250, 252, 254 of the first magnetic element 260. The arrangement of the magnet 310 and the first magnetic element 260 couples magnetic flux from the magnet into the first magnetic element. Since the limbs of the first magnetic element are aligned with the limbs of the second magnetic element, the magnetic flux is coupled through the first magnetic element 260 and into the second magnetic element 320. A loop of magnetic flux is established between a pair of limbs of the first magnetic element and a pair of limbs of the second magnetic element. One such loop is illustrated in FIG. 5A. Each such loop will include the limb of the first magnetic element 260 adjacent which the magnet 310 is located. Thus, in the illustrated example, each such loop will include the central limb 252 of the first magnetic element 260.

A loop of magnetic flux is coupled through two limbs 252, 254 of the first magnetic element 260. Preferably, the limbs of the first magnetic element 260 through which the flux is coupled are adjacent limbs, but this need not be the case in all examples. Magnetic flux is coupled through a portion of the body 360 of the first magnetic element 260 between the two limbs 252, 254 through which the flux is coupled. Thus, the coupled flux of the loop of flux passes through a first limb 252 of the first magnetic element 260, a portion of the body 360 of the first magnetic element 260 and a second limb 254 of the first magnetic element 260.

The loop of magnetic flux is coupled through two limbs 344, 342 of the second magnetic element 320. Preferably, the limbs of the second magnetic element 320 through which the flux is coupled are adjacent limbs, but this need not be the case in all examples. Magnetic flux is coupled through a portion of the body 350 of the second magnetic element 320 between the two limbs 344, 342 through which the flux is coupled. Thus, the coupled flux of the loop of flux passes through a first limb 344 of the second magnetic element 320, a portion of the body 350 of the second magnetic element 320 and a second limb 342 of the second magnetic element 320.

Whilst not illustrated, there will also be a loop of magnetic flux established in the left part of FIG. 5A, having a direction of magnetic flux lines opposite to the direction of magnetic flux lines shown in the right part of the figure. That is, where the lines of flux are established in a clockwise direction (in the plane of the figure) for one loop, the lines of flux are established in an anticlockwise (counter-clockwise) direction for the other loop. As illustrated, the north pole of the magnet 310 is located radially inwardly of the south pole, thus the flux lines would be clockwise in the left part of FIG. 5A and are anticlockwise (counter-clockwise) in the right part of FIG. 5A.

The establishment of a loop of magnetic flux through both the first magnetic element 260 and the second magnetic element 320 causes attraction between the limbs of the first magnetic element and the limbs of the second magnetic element. This attraction acts to resist movement the limbs away from the aligned position. Thus, the magnetic flux flowing through the first magnetic element and the second magnetic element resists movement of the second actuator portion 220 relative to the first actuator portion 210. Hence, the magnetic flux flowing through the first magnetic element and the second magnetic element resists movement of the actuator away from a position in which limbs 250, 252, 254 of the first magnetic element 260 align with limbs 340, 342, 344 of the second magnetic element 320.

Thus, the actuator is magnetically holdable in positions in which such alignment occurs.

The actuator 200 is for a powered device. The actuator has a plurality of positions in which the actuator is magnetically held in position. The actuator comprises a first actuator portion 210 and a second actuator portion 220. The first actuator portion has a magnet 310 and a first magnetic element 260. The first magnetic element has a first plurality of limbs 250, 252, 254. The first actuator portion 210 is configured to direct magnetic flux of the magnet 310 through the first plurality of limbs.

The second actuator portion 220 is movably mountable to the first actuator portion. For example, the second actuator portion can comprise a cylindrical portion that is a push fit into a corresponding cylindrical recess in the first actuator portion. The end of the cylindrical portion can comprise a lip that engages with an annular recess in the inner surface of the cylindrical recess, so as to releasably mount the second actuator portion to the first actuator portion. It will be apparent that other mounting methods or mechanisms can readily be applied. In another example, the second actuator portion 220 can be mounted to the first actuator portion 210 by a mounting element that extends along the axis of rotation 290, such as a pin, which may have a washer fitted to an end thereof to retain the second actuator portion.

The second actuator portion 220 comprises a second magnetic element 320. The second magnetic element has a second plurality of limbs 340, 342, 344. The second plurality of limbs are configured to receive the magnetic flux from the first plurality of limbs 250, 252, 254.

The actuator 200 has a plurality of positions in which limbs 250, 252, 254 of the first plurality of limbs align with limbs 340, 342, 344 of the second plurality of limbs thereby to couple the magnetic flux through the first magnetic element 260 of the first actuator portion 210 into the second magnetic element 320 of the second actuator portion 220. The coupled magnetic flux acts to resist relative movement between the first actuator portion 210 and the second actuator portion 320. Thus, the coupled magnetic flux magnetically holds the actuator in positions in which limbs of the first plurality of limbs align with limbs of the second plurality of limbs.

The actuator 200 thus has a resistance to movement that is away from a position of the actuator in which it is magnetically held in position. There is a force that must be overcome for the actuator to move away from such a position. The actuator can be considered to be held in place by the magnetic flux flowing through the first magnetic element 260 and the second magnetic element 320. The actuator can be considered to be fixed in place by the magnetic flux flowing through the first magnetic element and the second magnetic element. The actuator can be considered to be locked in place by the magnetic flux flowing through the first magnetic element and the second magnetic element. It will be understood that the terms ‘fixed’ and/or ‘locked’ herein do not imply that the actuator is not movable away from the position in which it is magnetically held, but that there is an impedance to such movement. That is, there is a resistance to movement that must be overcome before the actuator can be moved away from this position.

The force needed to overcome this resistance to movement can be considered to be a threshold force. The threshold force suitably depends, amongst other things, on the magnetic flux density of the magnetic flux passing through the second magnetic element 320 of the second actuator portion 220. This magnetic flux density depends on the strength of the magnet 310 of the first actuator portion 210, the size of the magnet of the first actuator portion, the material of the first magnetic element 260, the material of the second magnetic element, the size of the first magnetic element, the size of the second magnetic element, the shape of the first magnetic element, the shape of the second magnetic element, the spacing between the first magnetic element and the second magnetic element, the direction of relative movement between the first magnetic element and the second magnetic element.

The threshold force, i.e. the force with which the actuator is held in position, can therefore be selected as desired for a given application or use of the actuator 200. The arrangement described herein thus offers a high level of flexibility in the design and construction of the actuator. The arrangement described herein offers the ability to tailor the threshold force for the particular application. Since some design options will increase the threshold force (e.g. a limb material with a relatively higher magnetic permeability or a relatively greater thickness of the limb that couples a relatively greater magnetic flux density) and other design options will decrease the threshold force (e.g. a limb material with a relatively lower magnetic permeability or a relatively smaller thickness of the limb that couples a relatively smaller magnetic flux density), the physical configuration of the actuator, including the size, materials and weight, can be balanced with the desired threshold force.

Thus, the threshold force can be selected as desired, and the actuator components and configuration selected so as to obtain that desired threshold force. A subset of the actuator components and/or the actuator configuration can be selected as desired, and the remainder of the actuator components and/or the actuator configuration can be selected to obtain a desired threshold force.

Suitably one of, or a combination of one or more of, the following are selected in dependence on a desired threshold force.
the strength of the magnet of the first actuator portion,
the size of the magnet of the first actuator portion,
the material of the first magnetic element,
the material of the second magnetic element,
the size of the first magnetic element,
the size of the second magnetic element,
the shape of the first magnetic element,
the shape of the second magnetic element,
the configuration of the first magnetic element,
the configuration of the second magnetic element,
the spacing between the first magnetic element and the second magnetic element
the direction of relative movement between the first magnetic element and the second magnetic element.

Two or more limbs of the first plurality of limbs, i.e. limbs of the first magnetic element 260 of the first actuator portion 210, can be considered to form a first set of limbs. Two or more limbs of the second plurality of limbs, i.e. limbs of the second magnetic element 320 of the second actuator portion 220, can be considered to form a second set of limbs.

The actuator 200 suitably has a first position in which a first set of limbs comprising two or more limbs 250, 252, 254 of the first plurality of limbs aligns with a second set of limbs comprising two or more limbs 340, 342, 344 of the second plurality of limbs. Suitably, the first set of limbs aligns with the second set of limbs thereby to couple magnetic flux through the first set of limbs into the second set of limbs, the coupled magnetic flux resisting movement of the second actuator portion relative to the first actuator portion.

Thus, the magnetic flux from the magnet that is coupled into the first magnetic element of the first actuator portion and into the second magnetic element of the second actuator portion resists movement of the actuator away from the first position. The actuator is thereby magnetically held in the first position. The actuator can be considered to be locked in the first position.

A third set of limbs suitably comprises two or more limbs 250, 252, 254 of the first plurality of limbs, i.e. limbs of the first magnetic element 260 of the first actuator portion 210. The two or more limbs of the third set of limbs need not be the same as the two or more limbs of the first set of limbs. The third set of limbs and the first set of limbs may have limbs in common. The third set of limbs need not have limbs in common with the first set of limbs.

A fourth set of limbs suitably comprises two or more limbs 340, 342, 344 of the second plurality of limbs, i.e. limbs of the second magnetic element 320 of the second actuator portion 220. The two or more limbs of the fourth set of limbs need not be the same as the two or more limbs of the second set of limbs. The fourth set of limbs and the second set of limbs may have limbs in common. The fourth set of limbs need not have limbs in common with the second set of limbs.

The actuator 200 may have a second position in which the third set of limbs, comprising two or more limbs 250, 252, 254 of the first plurality of limbs, aligns with a fourth set of limbs, comprising two or more limbs 340, 342, 344 of the second plurality of limbs. In the second position the first set of limbs can differ from the third set of limbs, and/or the second set of limbs can differ from the fourth set of limbs. In the second position, the third set of limbs aligns with the fourth set of limbs thereby to couple magnetic flux through the third set of limbs into the fourth set of limbs, the coupled magnetic flux resisting movement of the second actuator portion relative to the first actuator portion. Thus, the actuator can be magnetically held in the second position.

In one example, a number of limbs of the first magnetic element 260 equals a number of limbs of the second magnetic element 320. Providing the first magnetic element and the second magnetic element with the same number of limbs helps to ensure alignment between limbs of each element as the second magnetic element moves past the first magnetic element. This arrangement helps ensure that the actuator can be magnetically secured in a plurality of positions.

In another example, a number of limbs of the first magnetic element 260 is greater than a number of limbs of the second magnetic element 320. Where the number of limbs of the first magnetic element and the second magnetic element differ, it can be advantageous to provide the first magnetic element with the greater number of limbs. Where the second magnetic element has relatively fewer limbs, the extent of travel of the second magnetic element can be shorter than when the second magnetic element has relatively more limbs. Thus, arrangements in which the second magnetic element has fewer limbs than the first magnetic element (e.g. where the second magnetic element has two limbs and the first magnetic element has three limbs) can result in more compact arrangements than might otherwise arise where the second magnetic element has more limbs than the first magnetic element (e.g. where the second magnetic element has three limbs and the first magnetic element has two limbs).

In other examples, a number of limbs of the first magnetic element 260 is smaller than a number of limbs of the second magnetic element 320.

Suitably, one or both of the first magnetic element 260 and the second magnetic element 220 comprises at least three limbs. Providing one or both of the first magnetic element and the second magnetic element with three limbs gives additional configurations in which limbs of each element can align with limbs of the other element. This results in additional positions in which the actuator can be magnetically held in place.

Further, where three limbs of the first magnetic element align with three limbs of the second magnetic element, magnetic flux can flow in two loops. This strengthens the force with which the actuator is magnetically held in position.

Suitably, limbs 250, 252, 254 of the first plurality of limbs of the first magnetic element 260 are spaced from each other by a separation (or angular) distance, d, and limbs 340, 342, 344 of the second plurality of limbs of the second magnetic element 220 are spaced from each other by the same separation (or angular) distance, d. Providing the same spacing/angle between two limbs of the first magnetic element as between two limbs of the second magnetic element helps with the alignment of limbs between the first magnetic element and the second magnetic element. In turn, the improved alignment helps couple magnetic flux more efficiently from the first magnetic element into the second magnetic element. This can improve the force with which the actuator is held in position.

In some examples, limbs of the first plurality of limbs of the first magnetic element are equally spaced from adjacent limbs of the first magnetic element. Providing equally-spaced limbs on the first magnetic element can help improve alignment of multiple pairs of limbs of the first magnetic element with two limbs of the second magnetic element. This arrangement can thereby improve the force with which the actuator is magnetically held in position.

In some examples, limbs of the second plurality of limbs of the second magnetic element are equally spaced from adjacent limbs of the second magnetic element. Providing equally-spaced limbs on the second magnetic element can help improve alignment of multiple pairs of limbs of the second magnetic element with two limbs of the first magnetic element. This arrangement can thereby improve the force with which the actuator is magnetically held in position.

Providing equally-spaced limbs on both the first magnetic element and the second magnetic element can help improve alignment of multiple pairs of limbs of the first magnetic element with multiple pairs of limbs of the second magnetic element. Providing equally-spaced limbs on both the first magnetic element and the second magnetic element can help improve alignment of three or more limbs of the first magnetic element with three or more limbs of the second magnetic element. This arrangement can thereby improve the force with which the actuator is magnetically held in position.

As illustrated in FIG. 4, for example, the second actuator portion can be rotatably mountable to the first actuator portion. This rotational mounting not necessary in all examples, as will be described in more detail elsewhere herein.

Rotationally mounting the second actuator portion to the first actuator portion, thereby enabling rotational movement between the first actuator portion and the second actuator portion, can lead to a more compact actuator configuration. This can therefore save space. Providing a compact actuator can be important on a handheld device, where space is often at a premium. Providing a compact actuator can help reduce the amount of materials used to manufacture the actuator, helping to correspondingly reduce the cost of manufacture. Providing a compact actuator can help reduce the weight of the actuator, which can be important on a handheld device. Reducing weight can reduce operator fatigue, thereby improving the ease of use of the device.

In examples where the second actuator portion 220 is rotatably mountable to the first actuator portion 210, the first plurality of limbs of the first magnetic element 260 can be radially exterior to the second plurality of limbs of the second magnetic element 320. This arrangement can provide for a more compact movable portion of the actuator, i.e. the second actuator portion 220. In this way, distinct positions of the actuator in which the actuator can be magnetically held in position can be provided with a relatively smaller movement than if the second magnetic element was radially exterior to the first magnetic element. This aids in the provision of a compact actuator and/or in providing a compact mode of operation of the actuator when moving between different positions of the actuator.

The first actuator portion 210 may be at least partially curved or arcuate. The first actuator portion 210 may be circular or generally circular. The first actuator portion 210 may be oval. The second actuator portion 220 may be at least partially curved or arcuate. The second actuator portion 220 may be circular or generally circular. The second actuator portion 220 may be oval. Providing one or both of the first actuator portion 210 and the second actuator portion 220 as arcuate or generally circular can help keep the actuator compact overall.

Suitably, at least a portion of the actuator 200 is formed by additive manufacturing (3D printing). Forming one or more portions or components of the actuator 200 by additive manufacturing can mean that that portion or component can be manufactured more quickly than using other manufacturing methods. Forming one or more portions or components of the actuator 200 by additive manufacturing can mean that that portion or component can be manufactured more quickly than using other manufacturing methods. Forming one or more portions or components of the actuator 200 by additive manufacturing can mean that that portion or component can be more lightweight than if manufactured using other manufacturing methods.

Suitably, one or both of the first magnetic element 260 and the second magnetic element 320 is at least partially ferromagnetic. Forming the first magnetic element 260 and/or the second magnetic element 320 partially or wholly from a ferromagnetic material can help couple the magnetic flux from the magnet 310 into these elements 260, 320. Improved magnetic flux coupling can improve the strength with which the actuator is magnetically held in position.

In some examples, one or both of the first magnetic element 260 and the second magnetic element 320 is at least partially made from metal. For example, one or both of the first magnetic element 260 and the second magnetic element 320 can be at least partially made from a ferromagnetic metal.

It is convenient for one or both of the first magnetic element 260 and the second magnetic element 320 to be formed by a milling process. Forming the one or both of the first magnetic element 260 and the second magnetic element 320 by milling can mean that one or both of these elements 260, 320 can be formed so as to reduce the volume of material needed for a given structural strength. Reducing the volume of one or both of these elements 260, 320 can reduce the overall weight of the actuator 200. The process for forming one or both of these elements 260, 320 may comprise other stages, i.e. the manufacturing process can comprise milling and one or more other processes.

Suitably, the actuator 200 is incorporated into a powered device such as a power tool. For example the actuator 200 can be incorporated into a hand tool, such as a battery powered hand tool.

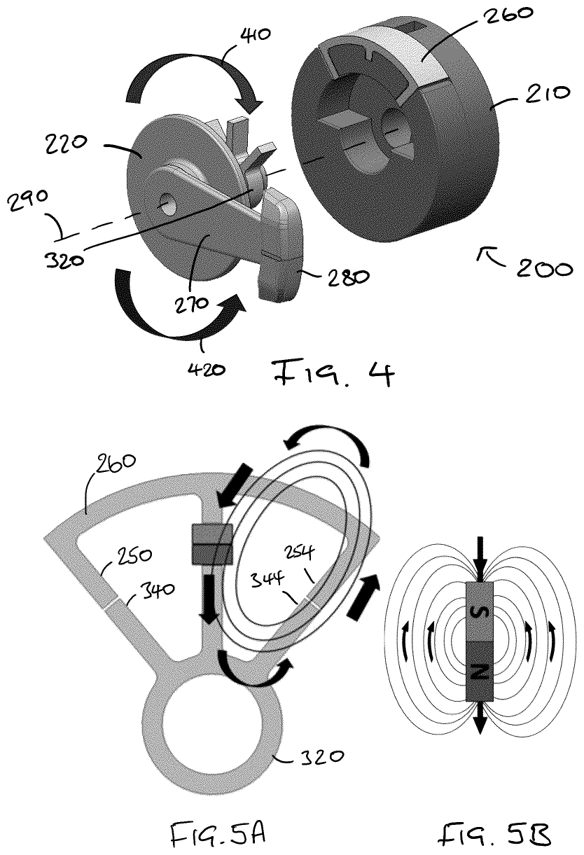

The principles of operation of the actuator 200 will be further described with reference to FIGS. 6A, 6B and 6C. FIG. 6A shows an actuator 200 in a lower actuator position. FIG. 6B shows the actuator 200 in a middle actuator position. FIG. 6C shows the actuator 200 in an upper actuator position. Here, ‘lower’, ‘middle’ and ‘upper’ simply refer to the relative positions, as viewed in FIGS. 6A, 6B and 6C, of the knob 280.

In the example illustrated in FIGS. 6A, 6B and 6C, the actuator 200 is a rotationally-operated actuator. The second actuator portion 220 is rotationally mounted to the first actuator portion 210. The first magnetic element 260 of the first actuator portion 210 comprises three limbs 250, 252, 254. The second magnetic element 320 of the second actuator portion 220 comprises three limbs 340, 342, 344. The limbs of the first magnetic element and the limbs of the second magnetic element have the same circumferential spacing as each other. The first magnetic element is radially exterior to the second magnetic element.

In the lower actuator position (FIG. 6A), two limbs 340, 342 of the second magnetic element align with two limbs 252, 254 of the first magnetic element. A single loop (indicated at 610) is formed by the alignment between these two pairs of limbs of each element 260, 320. Magnetic flux thus flows through this loop, and resists movement of the actuator 200 away from the lower actuator position.

The clockwise-most limb 344 of the second magnetic element is close to or abuts an edge 615 of the central recess 330. Contact between this clockwise-most limb 344 and the edge of the central recess restricts movement of the knob 280 in a clockwise direction.

Overcoming the attractive force between the limbs of the first magnetic element and the second magnetic element in the lower actuator position, and moving the knob anticlockwise (counter-clockwise) will magnetically disengage the limbs 252, 254 of the first magnetic element from the limbs 340, 342 of the second magnetic element. The knob will then be more freely movable than when in the lower actuator position. Moving the knob 280 further in the anticlockwise (counter-clockwise) direction, will result in the middle actuator position (FIG. 6B).

In the middle actuator position, three limbs 340, 342, 344 of the second magnetic element align with three limbs 250, 252, 254 of the first magnetic element. Two loops (indicated at 620, 622) are formed by the alignment between these three pairs of limbs of each element 260, 320. Magnetic flux thus flows through these loops, and resists movement of the actuator 200 away from the middle actuator position.

Overcoming the attractive force between the limbs of the first magnetic element and the second magnetic element in the middle actuator position, and moving the knob either anticlockwise (counter-clockwise) or clockwise will magnetically disengage the limbs 250, 252, 254 of the first magnetic element from the limbs 340, 342, 344 of the second magnetic element. The knob will then be more freely movable than when in the middle actuator position. Moving the knob 280 in the anticlockwise (counter-clockwise) direction from the middle actuator position, will result in the upper actuator position (FIG. 6C).

In the upper actuator position, two limbs 342, 344 of the second magnetic element align with two limbs 250, 252 of the first magnetic element. A single loop (indicated at 630) is formed by the alignment between these two pairs of limbs of each element 260, 320. Magnetic flux thus flows through this loop, and resists movement of the actuator 200 away from the upper actuator position.

The anticlockwise-most (counter-clockwise-most) limb 340 of the second magnetic element is close to or abuts an edge 635 of the central recess 330. Contact between this anticlockwise-most (counter-clockwise-most) limb 340 and the edge of the central recess restricts movement of the knob 280 in an anticlockwise (counter-clockwise) direction.

Overcoming the attractive force between the limbs of the first magnetic element and the second magnetic element in the upper actuator position, and moving the knob clockwise will magnetically disengage the limbs 250, 252 of the first magnetic element from the limbs 342, 344 of the second magnetic element. The knob will then be more freely movable than when in the upper actuator position. Moving the knob 280 further in the clockwise direction will result in the middle actuator position (FIG. 6B).

FIGS. 6A, 6B and 6C illustrate an actuator having three positions in which the actuator can be magnetically held. Other arrangements are possible.

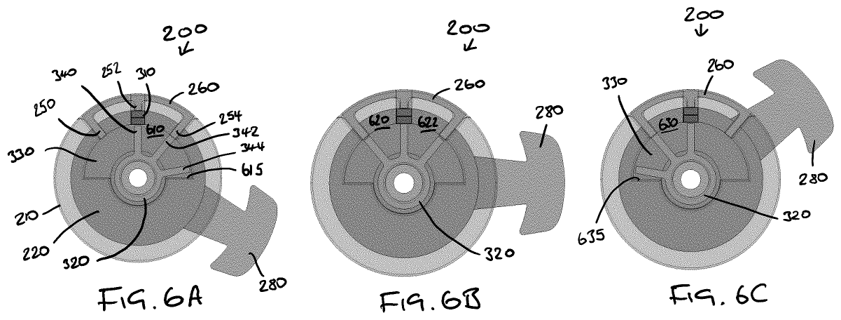

FIGS. 7A and 7B illustrate an example in which an actuator has two positions in which it can be magnetically held in position. In this example, the first magnetic element 260 is as described elsewhere herein, and comprises three limbs 250, 252, 254. The second magnetic element 700 comprises two limbs 710, 712. In the configuration illustrated in FIG. 7A, the actuator is shown in a first position. The two limbs 710, 712 of the second magnetic element 700 align with two of the limbs (250, 252, respectively) of the first magnetic element 260. In the configuration illustrated in FIG. 7B, the actuator is shown in a second position. The two limbs 710, 712 of the second magnetic element 700 align with two of the limbs (252, 254, respectively) of the first magnetic element 260. In both the first and second positions, the alignment of the limbs couples magnetic flux of the magnet 310 through the limbs (250, 252 or 252, 254) of the first magnetic element and through the limbs (710, 712) of the second magnetic element. The flux loops thus set up will act to resist movement of the actuator away from these positions, thereby acting to magnetically hold the actuator in these two positions.

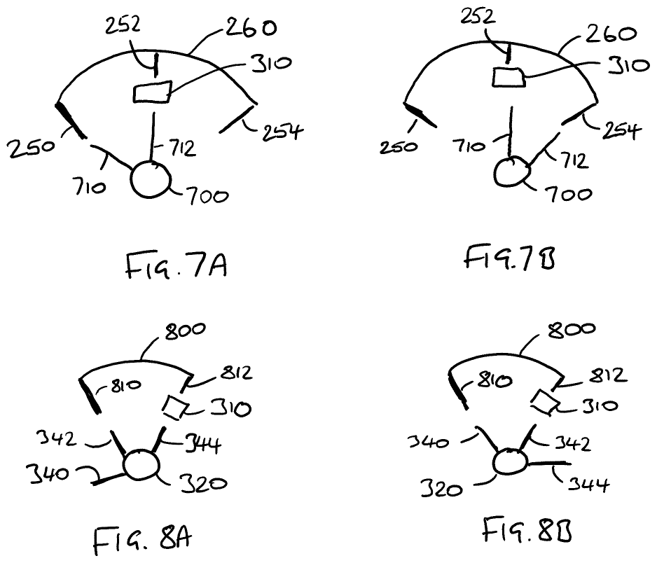

A further example is illustrated in FIGS. 8A and 8B. These figures illustrate another example in which an actuator has two positions in which it can be magnetically held in position. In this example, the second magnetic element 320 is as described elsewhere herein, and comprises three limbs 340, 342, 344. The first magnetic element 800 comprises two limbs 810, 812. In the configuration illustrated in FIG. 8A, the actuator is shown in a first position. The two limbs 810, 812 of the first magnetic element 800 align with two of the limbs (342, 344, respectively) of the second magnetic element 320. In the configuration illustrated in FIG. 8B, the actuator is shown in a second position. The two limbs 810, 812 of the first magnetic element 800 align with two of the limbs (340, 342, respectively) of the second magnetic element 320. In both the first and second positions, the alignment of the limbs couples magnetic flux of the magnet 310 through the limbs (342, 344 or 340, 342) of the second magnetic element and through the limbs (810, 812) of the first magnetic element. The flux loops thus set up will act to resist movement of the actuator away from these positions, thereby acting to magnetically hold the actuator in these two positions.

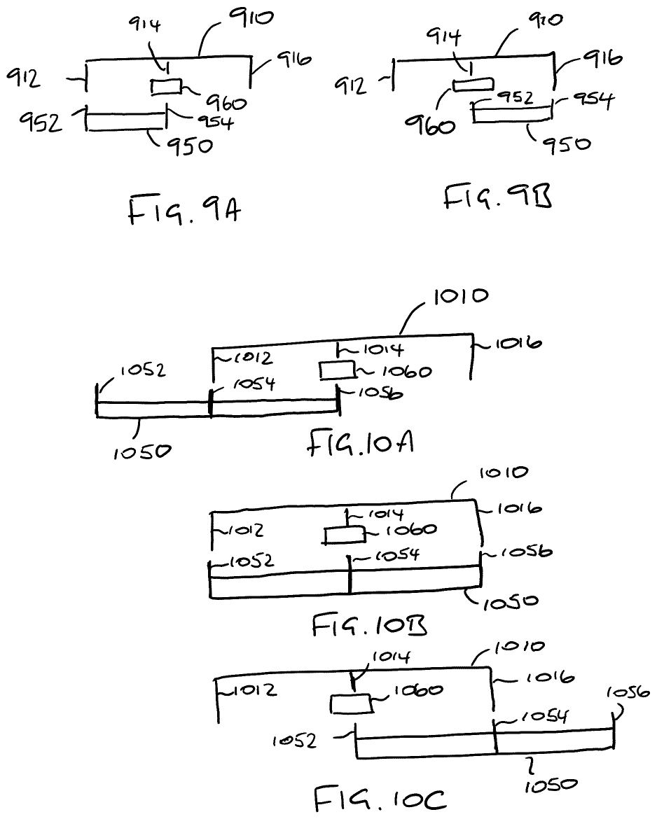

Examples of an actuator 200 in which the second actuator portion 220 is rotatably mountable to the first actuator portion 210 have thus far been described. Other types of relative movement between the second actuator portion and the first actuator portion are possible, utilising the techniques discussed herein. Some non-limiting examples of these will now be described with reference to FIGS. 9A, 9B, 10A, 10B and 10C. Characteristics and configurations of the rotatably-actuated actuator apply to the linearly-actuated actuator.

FIGS. 9A and 9B illustrate an example in which an actuator has two positions in which it can be magnetically held in position. The actuator in this example comprises a first magnetic element 910 and a second magnetic element 950. The first magnetic element 910 comprises three limbs 912, 914, 916. The limbs 912, 914, 916 protrude from a body of the first magnetic element 910. A magnet 960 is located adjacent a central limb 960. The second magnetic element 950 comprises two limbs 952, 954. The limbs 952, 954 protrude from a body of the second magnetic element 950. In this example, the second magnetic element 950 is linearly movable relative to the first magnetic element 910.

The limbs 912, 914, 916 on the first magnetic element 910 extend from the body of the first magnetic element 910. The limbs on the first magnetic element 910 are separated from one another. In the configuration illustrated in FIGS. 9A and 9B, the limbs are separated from one another in the direction of relative movement between the first and second magnetic elements, i.e. linearly. As illustrated, the limbs 912, 914, 916 extend perpendicularly from the body of the first magnetic element 910. The limbs 952, 954 on the second magnetic element 950 extend from the body of the second magnetic element 950. The limbs 952, 954 on the second magnetic element 950 are separated from one another. In the configuration illustrated in FIGS. 9A and 9B, the limbs 952, 954 are separated from one another in the direction of relative movement between the first and second magnetic elements, i.e. linearly. As illustrated, the limbs 952, 954 extend perpendicularly from the body of the second magnetic element 950.

In the illustrated example, the limbs 912, 914, 916 of the first magnetic element 910 protrude at an angle to a generally longitudinal axis of the first magnetic element that is approximately 90 degrees. The limbs can protrude at an angle in the range 75-105 degrees, preferably 80-100 degrees, more preferably 85-95 degrees. Preferably, each limb protrudes at the same angle, though this is not necessary in all examples. It is convenient for the limbs to protrude at the same angle, as this ensures equivalent coupling of each limb with a limb of the second magnetic element 950. It is convenient for the limbs to protrude at approximately 90 degrees, so that the limbs are configured to protrude directly towards limbs of the second magnetic element 950. Preferably, a distal end face of each limb is configured to directly face a limb of the second magnetic element 950, in an aligned position.

In the configuration illustrated in FIG. 9A, the actuator is shown in a first position. The two limbs 952, 954 of the second magnetic element 950 align with two of the limbs (912, 914, respectively) of the first magnetic element 910. In the configuration illustrated in FIG. 9B, the actuator is shown in a second position. The two limbs 952, 954 of the second magnetic element 950 align with two of the limbs (914, 916, respectively) of the first magnetic element 910. In both the first and second positions, the alignment of the limbs couples magnetic flux of the magnet 960 through the limbs (912, 914 or 914, 916) of the first magnetic element and through the limbs (952, 954) of the second magnetic element. The flux loops thus set up will act to resist movement of the actuator away from these positions, thereby acting to magnetically hold the actuator in these two positions.

By a comparison with the example actuators illustrated in FIGS. 7A, 7B, 8A, 8B, at least, it will be appreciated that a linear actuator can be provided which has a greater number of limbs on the second magnetic element (e.g. three limbs) than on the first magnetic element (e.g. two limbs).

FIGS. 10A, 10B and 10C illustrate a further example of an actuator that can be magnetically held in a plurality of positions. In this example, the second magnetic element is linearly movable relative to the first magnetic element between a leftmost position, a central position and a rightmost position. The actuator illustrated in these figures comprises a first magnetic element 1010 having three limbs 1012, 1014, 1016. A magnet 1060 is located adjacent a central limb 1014. The illustrated actuator comprises a second magnetic element 1050 having three limbs 1052, 1054, 1056.

In the leftmost actuator position (FIG. 10A), two limbs 1054, 1056 of the second magnetic element 1050 align with two limbs 1012, 1014 of the first magnetic element 1010. A single loop is formed by the alignment between these two pairs of limbs of each element 1010, 1050. Magnetic flux thus flows through this loop, and resists movement of the actuator away from the leftmost actuator position.

Overcoming the attractive force between the limbs of the first magnetic element and the second magnetic element in the leftmost actuator position, and moving the second magnetic element 1050 to the right (in the orientation of FIG. 10A) will magnetically disengage the limbs 1012, 1014 of the first magnetic element 1010 from the limbs 1054, 1056 of the second magnetic element 1050. The second magnetic element 1050 will then be more freely movable than when in the leftmost actuator position. Moving the second magnetic element 1050 further to the right will result in the central actuator position (FIG. 10B).

In the central actuator position, three limbs 1052, 1054, 1056 of the second magnetic element 1050 align with three limbs 1012, 1014, 1016 of the first magnetic element 1010. Two loops are formed by the alignment between these three pairs of limbs of each element 1010, 1050. Magnetic flux thus flows through these loops, and resists movement of the actuator away from the central actuator position.

Overcoming the attractive force between the limbs of the first magnetic element 1010 and the second magnetic element 1050 in the central actuator position, and moving the second magnetic element 1050 either to the right or left (in the orientation of FIG. 10B) will magnetically disengage the limbs 1012, 1014, 1016 of the first magnetic element 1010 from the limbs 1052, 1054, 1056 of the second magnetic element 1050. The second magnetic element 1050 will then be more freely movable than when in the central actuator position. Moving the second magnetic element 1050 to the right from the central actuator position, will result in the rightmost actuator position (FIG. 10C).

In the rightmost actuator position, two limbs 1052, 1054 of the second magnetic element 1050 align with two limbs 1014, 1016 of the first magnetic element 1010. A single loop is formed by the alignment between these two pairs of limbs of each element 1010, 1050. Magnetic flux thus flows through this loop, and resists movement of the actuator away from the rightmost actuator position.

Overcoming the attractive force between the limbs of the first magnetic element 1010 and the second magnetic element 1050 in the rightmost actuator position, and moving the second magnetic element 1050 to the left (in the orientation of FIG. 10C) will magnetically disengage the limbs 1052, 1054 of the second magnetic element 1050 from the limbs 1014, 1016 of the first magnetic element 1010. The second magnetic element 1050 will then be more freely movable than when in the rightmost actuator position. Moving the second magnetic element 1050 further to the left will result in the central actuator position (FIG. 10B).

Characteristics of the actuator illustrated in FIGS. 9A and 9B apply to the actuator illustrated in FIGS. 10A to 10C. That is, limbs 1012, 1014, 1016 on the first magnetic element 1010 extend from the body of the first magnetic element 1010. The limbs on the first magnetic element 1010 are separated from one another. In the illustrated configuration, the limbs are separated from one another in the direction of relative movement between the first and second magnetic elements, i.e. linearly. As illustrated, the limbs 1012, 1014, 1016 extend perpendicularly from the body of the first magnetic element 1010, but they need not do so, as described with reference to the example of FIGS. 9A and 9B.

The limbs 1052, 1054, 1056 on the second magnetic element 1050 extend from the body of the second magnetic element 1050. The limbs 1052, 1054, 1056 on the second magnetic element 1050 are separated from one another. In the illustrated configuration, the limbs 1052, 1054, 1056 are separated from one another in the direction of relative movement between the first and second magnetic elements, i.e. linearly. As illustrated, the limbs 1052, 1054, 1056 extend perpendicularly from the body of the second magnetic element 1050, but they need not do so, as described with reference to the example of FIGS. 9A and 9B.

The limbs of the first or second magnetic elements 1010, 1050 protrude at an angle to a generally longitudinal axis of the respective first or second magnetic element that is approximately 90 degrees. The limbs can protrude at an angle in the range 75-105 degrees, preferably 80-100 degrees, more preferably 85-95 degrees. Preferably, each limb protrudes at the same angle, though this is not necessary in all examples. It is convenient for the limbs to protrude at the same angle, as this ensures equivalent coupling of each limb of one of the first and second magnetic elements with a limb of the other of the first and second magnetic elements. It is convenient for the limbs to protrude at approximately 90 degrees, so that the limbs are configured to protrude directly towards limbs of the other magnetic element. Preferably, a distal end face of each limb is configured to directly face a limb of the other magnetic element, in an aligned position.

In an aligned position, as illustrated in FIG. 9A, a loop of magnetic flux is coupled through two limbs 912, 914 of the first magnetic element 910. Preferably, the limbs of the first magnetic element 910 through which the flux is coupled are adjacent limbs, but this need not be the case in all examples. Magnetic flux is coupled through a portion of the body of the first magnetic element 910 between the two limbs 912, 914 through which the flux is coupled. Thus, the coupled flux of the loop of flux passes through a first limb 912 of the first magnetic element 910, a portion of the body of the first magnetic element 910 and a second limb 914 of the first magnetic element 910.

The loop of magnetic flux is coupled through two limbs 954, 952 of the second magnetic element 950. Preferably, the limbs of the second magnetic element 950 through which the flux is coupled are adjacent limbs, but this need not be the case in all examples. Magnetic flux is coupled through a portion of the body of the second magnetic element 950 between the two limbs 954, 952 through which the flux is coupled. Thus, the coupled flux of the loop of flux passes through a first limb 954 of the second magnetic element 950, a portion of the body of the second magnetic element 950 and a second limb 952 of the second magnetic element 950.

Similarly, in the configuration of FIG. 10A, in an aligned position, a loop of magnetic flux is coupled through two limbs 1012, 1014 of the first magnetic element 1010. Preferably, the limbs of the first magnetic element 1010 through which the flux is coupled are adjacent limbs, but this need not be the case in all examples. Magnetic flux is coupled through a portion of the body of the first magnetic element 1010 between the two limbs 1012, 1014 through which the flux is coupled. Thus, the coupled flux of the loop of flux passes through a first limb 1012 of the first magnetic element 1010, a portion of the body of the first magnetic element 1010 and a second limb 1014 of the first magnetic element 1010.

The loop of magnetic flux is coupled through two limbs 1056, 1054 of the second magnetic element 1050. Preferably, the limbs of the second magnetic element 1050 through which the flux is coupled are adjacent limbs, but this need not be the case in all examples. Magnetic flux is coupled through a portion of the body of the second magnetic element 1050 between the two limbs 1056, 1054 through which the flux is coupled. Thus, the coupled flux of the loop of flux passes through a first limb 1056 of the second magnetic element 1050, a portion of the body of the second magnetic element 1050 and a second limb 1054 of the second magnetic element 1050.

In the configurations illustrated in FIGS. 9A, 9B and 10A to 10C, a single magnet (a permanent magnet and/or an electromagnet) is preferably provided. The first and second magnetic elements couple flux of the magnet. Thus, it is sufficient for a single magnet to be provided to enable a flux circuit to be set up that includes a portion of the first magnetic element and a portion of the second magnetic element. Providing a single magnet can assist with reducing cost and/or complexity of manufacture.

In the linearly-movable configurations described herein, the magnet is preferably provided between a portion of the first magnetic element and a portion of the second magnetic element, preferably between a limb of the first magnetic element and a limb of the second magnetic element, in an aligned configuration. This arrangement can help keep the actuator compact. In such arrangements, the magnetic flux loop through two limbs of one magnetic element and two limbs of the other magnetic element occurs generally in a plane aligned with the direction of relative linear movement between the first and second magnetic elements.

The limbs of the first magnetic element can be of the same material as the body of the first magnetic element. Preferably, the limbs of the first magnetic element are unitarily formed with the body of the first magnetic element. This can simplify manufacture of the first magnetic element, and assembly of the actuator. The limbs of the second magnetic element can be of the same material as the body of the second magnetic element. Preferably, the limbs of the second magnetic element are unitarily formed with the body of the second magnetic element. This can simplify manufacture of the second magnetic element, and assembly of the actuator. Preferably, the multiple limbs of the magnetic elements are not themselves magnets, but are of a material for coupling magnetic flux, so as to couple flux from the separate magnet through the magnetic elements.

In the foregoing, examples have been described in which the magnet 310, 960, 1060 is provided adjacent the first magnetic element 260, 800, 910, 1010. This need not be the case in all examples. The present techniques remain applicable where the magnet is provided adjacent the second magnetic element 320, 700, 950, 1050.

Thus, in some examples, the magnet is provided adjacent the second magnetic element, for example adjacent a central limb 342, 1054 of the second magnetic element 320, 1050, or adjacent (for example) a right-hand limb 712, 954 of the second magnetic element 700, 950. In these examples, the magnet can be arranged to remain in registration with the second magnetic element. That is, where the second magnetic element is movable, the magnet is suitably arranged to move in registration with the second magnetic element. It is noted that the second magnetic element need not be movable in all examples.

In the example described with reference to FIG. 3, the second actuator portion can be movable past the first actuator portion. This is not necessary. The first actuator portion and the second actuator portion are movable relative to one another. It does not matter whether it is the first actuator portion that moves past the second actuator portion, or whether it is the second actuator portion that moves past the first actuator portion. Suitably one of the two actuator portions is movable to a greater extent than the other. For example, one of the two actuator portions can be fixed to (i.e. non-movable relative to) a device body of a powered tool.

The actuator portion described herein as the first actuator portion may be considered to be the second actuator portion, and the actuator portion described herein as the second actuator portion may be considered to be the first actuator portion.

Where the magnet is provided as part of the first actuator portion, the magnet can be provided adjacent (for example) a right-hand limb 254, 1016 of the first magnetic element 260, 1010.

Where three or more limbs are provided in the magnetic element adjacent which the magnet is located, it is preferable to locate the magnet adjacent a limb that is not at either end of the magnetic element, i.e. a central or ‘internal’ limb. Referring to FIG. 5A, it will be seen that locating the magnet away from an end limb means that multiple magnetic flux loops can be set up between limbs of the first and second magnetic elements in at least some positions of the actuator. This arrangement therefore leads to enhanced resistance to movement in such positions of the actuator.

In some examples, at least a portion of a limb of one of the first magnetic element and the second magnetic element can form the magnet. That is, a limb of the magnetic element can comprise the magnet. Suitably, at least a portion of a central limb of the magnetic element forms the magnet. The whole limb could form the magnet. In such arrangements, the magnet can still be considered to be adjacent a remainder of the respective magnetic element.

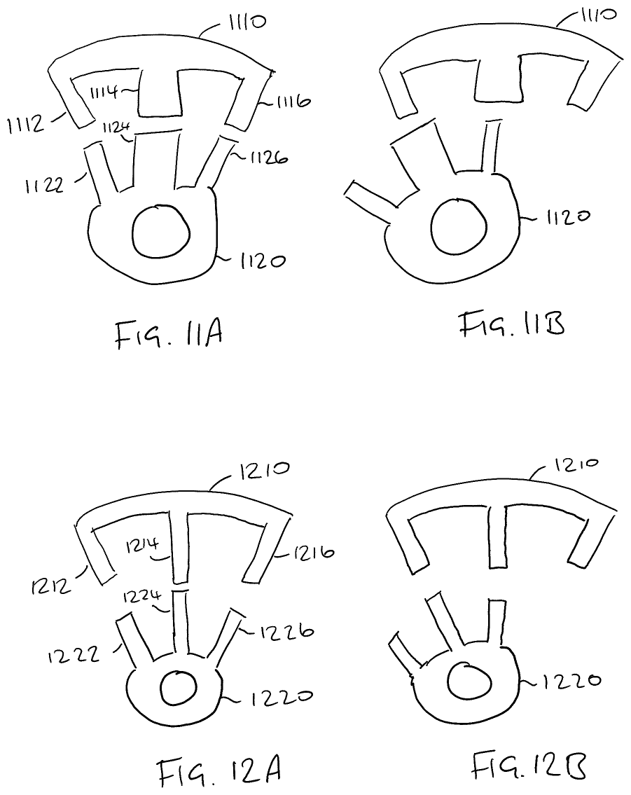

In the foregoing, a threshold force was introduced, which is a force with which the actuator is held in position, or retained in position. In some examples, it is possible to achieve different retention forces for different positions of the actuator. As described above, the magnet can comprise an electromagnet. Controlling the electromagnet to have differing strengths in different actuator positions can achieve such differing retention forces in the different actuator positions. Alternatively, or additionally, a structural configuration of the actuator can provide for differing retention forces in different actuator positions, as will now be explained with reference to FIGS. 11A, 11B, 12A and 12B.

FIGS. 11A and 11B show an example in which the first and second magnetic elements comprise limbs with differing circumferential widths. A first magnetic element 1110 comprises three limbs (though other numbers of limbs can be provided, as described elsewhere herein). In the orientation of FIG. 11A, a central limb 1114 is wider than both a left-most limb 1112 and a right-most limb 1116. The left-most limb and the right-most limb are of equal widths in this example, but this need not be the case. A second magnetic element 1120 comprises three limbs (though other numbers of limbs can be provided, as described elsewhere herein). In the orientation of FIG. 11A, a central limb 1124 is wider than both a left-most limb 1122 and a right-most limb 1126. The left-most limb and the right-most limb are of equal widths in this example, but this need not be the case.

FIG. 11A shows a configuration of the actuator where the central limb 1114 of the first magnetic element 1110 aligns with the central limb 1124 of the second magnetic element 1120. Thus, the full width of the central limbs overlap each other. The remaining limbs of the first magnetic element align (and fully overlap) with the remaining limbs of the second magnetic element.

FIG. 11B shows a configuration of the actuator where the central limb 1114 of the first magnetic element 1110 aligns with the right-most limb 1126 of the second magnetic element 1120, and the central limb 1124 of the second magnetic element 1120 aligns with the left-most limb 1112 of the first magnetic element 1110. The aligned limbs do not fully overlap with one another because they are of different circumferential widths.

It will be understood that the coupling of magnetic flux (and hence the retention force) will differ in dependence on the amount of overlap between limbs of the first magnetic element and limbs of the second magnetic element. It is possible to tailor the respective widths of the limbs to achieve different relative retention forces in the different positions of the actuator. Where more than two positions of the actuator are provided, each position may result in a different retention force, or multiple positions may result in a common retention force.

In the examples illustrated in FIGS. 11A and 11B, the circumferential width of the limbs differ. An alternative approach is to vary the axial width (i.e. an extent of the limbs along longitudinal axis 290). Such variation of the axial width will also result in differing overlaps between limbs in the different actuator positions, thereby varying the retention force.

In other examples, both the circumferential width and axial width can be varied, in any desired combination of the limbs of the first and second magnetic elements.

Another approach will now be described with reference to FIGS. 12A and 12B. FIGS. 12A and 12B show an example in which the first and second magnetic elements comprise limbs with differing radial lengths. A first magnetic element 1210 comprises three limbs (though other numbers of limbs can be provided, as described elsewhere herein). In the orientation of FIG. 12A, a central limb 1214 is longer than both a left-most limb 1212 and a right-most limb 1216. The left-most limb and the right-most limb are of equal lengths in this example, but this need not be the case. A second magnetic element 1220 comprises three limbs (though other numbers of limbs can be provided, as described elsewhere herein). In the orientation of FIG. 12A, a central limb 1224 is longer than both a left-most limb 1222 and a right-most limb 1226. The left-most limb and the right-most limb are of equal lengths in this example, but this need not be the case.

FIG. 12A shows a configuration of the actuator where the central limb 1214 of the first magnetic element 1210 aligns with the central limb 1224 of the second magnetic element 1220. Thus, the central limbs are closer to each other than the other limbs are to their facing limbs.

FIG. 12B shows a configuration of the actuator where the central limb 1214 of the first magnetic element 1210 aligns with the right-most limb 1226 of the second magnetic element 1220, and the central limb 1224 of the second magnetic element 1220 aligns with the left-most limb 1212 of the first magnetic element 1210. The aligned limbs do not approach each other as closely as in the configuration shown in FIG. 12A.

It will be understood that the coupling of magnetic flux (and hence the retention force) will differ in dependence on the separation distance between facing limbs of the first and second magnetic elements. It is possible to tailor the respective lengths of the limbs to achieve different relative retention forces in the different positions of the actuator. Where more than two positions of the actuator are provided, each position may result in a different retention force, or multiple positions may result in a common retention force.

In other examples, any two or more of the circumferential width of one or more limb, axial width of one or more limb, and length of one or more limb can be varied to vary the retention force for an actuator position.

The actuator can comprise a biasing means. For example, the biasing means can comprise a resilient element such as a spring. The biasing means is suitably configured to bias the actuator towards a given actuator position. Thus, the bias force resulting from the biasing means can be additional to the retention force when the actuator is in the given actuator position. The bias force can reduce the force needed to move the actuator from another actuator position towards the given actuator position. The provision of the biasing means can mean that a lower retention force is needed to retain the actuator in the given actuator position.

Suitably, the retention forces can differ between different actuator positions to aid in the safe operation of a powered device. For example, some switching operations are more safety critical against unintended switching than others. For example, switching from chisel mode to hammer drill mode is potentially more dangerous than another mode change, because the rotation of the spindle could cause a hazard, if the user is not aware.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

We claim:

1. An actuator for actuating a switch of a powered device, the actuator having a plurality of positions in which the actuator is magnetically held in position, the actuator comprising:
a first actuator portion comprising a magnet and a first magnetic element having a first plurality of limbs, whereby magnetic flux of the magnet is directed through the first plurality of limbs; and
a second actuator portion comprising a second magnetic element having a second plurality of limbs for receiving the magnetic flux from the first plurality of limbs, wherein the second actuator portion is movable relative to the first actuator portion;
the actuator having a plurality of positions in which limbs of the first plurality of limbs align with limbs of the second plurality of limbs thereby to couple the magnetic flux in a flux loop through two limbs of the first plurality of limbs of the first magnetic element and two limbs of the second plurality of limbs of the second magnetic element, the coupled magnetic flux resisting relative movement between the first actuator portion and the second actuator portion.

2. An actuator as claimed in claim 1, in which one or more of
a strength and/or a size of the magnet,
a material of the first magnetic element and/or a material of the second magnetic element,
a size and/or shape of the first magnetic element,
a size and/or shape of the second magnetic element,
a spacing between the first magnetic element and the second magnetic element,
a direction of relative movement between the first magnetic element and the second magnetic element,
are selected in dependence on a desired force with which the actuator is magnetically held in position.

3. An actuator as claimed in claim 1, in which the magnet comprises a permanent magnet or an electromagnet.

4. An actuator as claimed in claim 1, in which the actuator has:
a first position in which a first set of limbs comprising two or more limbs of the first plurality of limbs aligns with a second set of limbs comprising two or more limbs of the second plurality of limbs; and
a second position in which a third set of limbs comprising two or more limbs of the first plurality of limbs aligns with a fourth set of limbs comprising two or more limbs of the second plurality of limbs,
wherein the first set of limbs differs from the third set of limbs; and/or
wherein the second set of limbs differs from the fourth set of limbs.

5. An actuator as claimed in claim 1, in which the first plurality of limbs is unitarily formed with the remainder of the first magnetic element, and/or in which the second plurality of limbs is unitarily formed with the remainder of the second magnetic element.

6. An actuator as claimed in claim 1, in which a number of limbs of the first magnetic element is equal to or greater than a number of limbs of the second magnetic element.

7. An actuator as claimed in claim 1, in which one or both of the first magnetic element and the second magnetic element comprises at least three limbs.

8. An actuator as claimed in claim 1, in which limbs of the first plurality of limbs of the first magnetic element are spaced from each other by a separation distance, and limbs of the second plurality of limbs of the second magnetic element are spaced from each other by the same separation distance.

9. An actuator as claimed in claim 1, in which limbs of the first plurality of limbs of the first magnetic element are equally spaced from adjacent limbs; and/or in which limbs of the second plurality of limbs of the second magnetic element are equally spaced from adjacent limbs.

10. An actuator as claimed in claim 1, in which one or more limbs of the first magnetic element may have at least one of:
a different circumferential width,
a different axial width, and
a different length,
compared to one or more limbs of the second magnetic element.

11. An actuator as claimed in claim 1, comprising biasing means configured to bias the actuator towards an actuator position.

12. An actuator as claimed in claim 1, in which the second actuator portion is rotatably movable relative to the first actuator portion.

13. An actuator as claimed in claim 12, in which the first plurality of limbs of the first magnetic element are radially exterior to the second plurality of limbs of the second magnetic element.

14. An actuator as claimed in claim 12, in which the magnet is radially between the first magnetic element and the second magnetic element.

15. A powered device comprising an actuator for actuating a switch of a powered device, the actuator having a plurality of positions in which the actuator is magnetically held in position, the actuator comprising:
a first actuator portion comprising a magnet and a first magnetic element having a first plurality of limbs, whereby magnetic flux of the magnet is directed through the first plurality of limbs; and
a second actuator portion comprising a second magnetic element having a second plurality of limbs for receiving the magnetic flux from the first plurality of limbs, wherein the second actuator portion is movable relative to the first actuator portion;
the actuator having a plurality of positions in which limbs of the first plurality of limbs align with limbs of the second plurality of limbs thereby to couple the magnetic flux in a flux loop through two limbs of the first plurality of limbs of the first magnetic element and two limbs of the second plurality of limbs of the second magnetic element, the coupled magnetic flux resisting relative movement between the first actuator portion and the second actuator portion,
wherein one of the first actuator portion and the second actuator portion is movable relative to a device body of the powered device.
